(19) United States
(12) Patent Application Publication
(10) Pub. No.: US 2020/0395975 A1
(43) Pub. Date: Dec. 17, 2020

(54) POSITION DETERMINATION SYSTEM

(71) Applicant: KABUSHIKI KAISHA TOKAI RIKA DENKI SEISAKUSHO, Aichi (JP)

(72) Inventor: Tsuyoshi KIMURA, Aichi (JP)

(73) Assignee: KABUSHIKI KAISHA TOKAI RIKA DENKI SEISAKUSHO, Aichi (JP)

(21) Appl. No.: 16/894,954

(22) Filed: Jun. 8, 2020

(30) Foreign Application Priority Data
Jun. 12, 2019 (JP) 2019-109543

(51) Int. Cl. H04B 1/713; H04W 4/40; H04W 64/00; H04W 76/40; H04W 76/15

(52) U.S. Cl. CPC H04B 1/713; H04W 4/40; H04W 76/15; H04W 76/40; H04W 64/003

(57) ABSTRACT

A position determination system includes a determination unit that repeats a position determination process in predetermined cycles to determine the present position of the terminal in each cycle. In the position determination process, the determination unit obtains a measurement value that indicates a characteristic of radio waves transmitted between a communication device and a terminal to determine the position of the terminal relative to the communication device from the measurement value. The determination unit manages the position of the terminal through a determination control that allows a position determination result to be maintained over a number of the predetermined cycles.

### BACKGROUND

### 1. Field

The following description relates to a position determination system that determines a position of a terminal relative to a communication device.

### 2. Description of Related Art

A conventional position determination system determines a position of a terminal relative to a communication device through near-range wireless communication between the terminal and the communication device (refer to Japanese Laid-Open Patent Publication No. 2018-12933). This type of position determination system, for example, measures a received signal strength indicator of radio waves transmitted and received between the communication device and the terminal to obtain the positional relationship of the communication device and the terminal from the measurement value.

### SUMMARY

It is important that the terminal position determination accuracy of the position determination system be improved. For example, When the position determination system is applied to a vehicle, the terminal may be used as a vehicle key. Thus, when a user operates the vehicle with the terminal, it is necessary that the position of the terminal be accurately determined to properly actuate the vehicle in accordance with the position and intention of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a position determination system includes a determination unit. The determination unit obtains a measurement value indicating a characteristic of radio waves transmitted between a communication device and a terminal, repeats a position determination process that determines a position of the terminal relative to the communication device from the measurement value in a plurality of cycles each having a predetermined cycle, and determines a present position of the terminal in each of the cycles. The determination unit manages the position of the terminal through a determination control that allows a position determination result to be maintained over a number of the cycles.

In another general aspect, a computer system includes one or more processors and a non-transitory memory that stores instructions which are executable by the processors to execute a position determination process. The position determination process includes obtaining a measurement value that indicates a characteristic of radio waves transmitted between a communication device arranged in a subject and a terminal; determining a present position of the terminal relative to the subject from the measurement value; determining whether a position update permission condition is satisfied; maintaining a position determination result that indicates the present position of the terminal until the position update permission condition is satisfied; and allowing for updating of the position determination result in response to determining the position update permission condition has been satisfied.

Other features and aspects will he apparent from the following detailed description, the drawings, and the claims.

### BRIEF DESCRIPTION OF THE DRAWINGS

FIG. 1 is a diagram illustrating the configuration of a position determination system in accordance with one embodiment.

FIGS. 2A to 2C are schematic diagrams illustrating examples of various positions of a terminal relative to a vehicle.

FIG. 3 is a schematic flowchart illustrating a communication sequence.

FIG. 4 is a diagram illustrating an example of how terminal position determination shifts.

FIG. 5A is a diagram illustrating an example in which a position determination result is maintained with respect to the transition of the position determination.

FIG. 5B is a diagram illustrating an example in which the position determination result is changed with respect to the transition of the position determination.

FIG. 6 is a diagram illustrating another example in which the position determination result is maintained with respect to the transition of the position determination.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

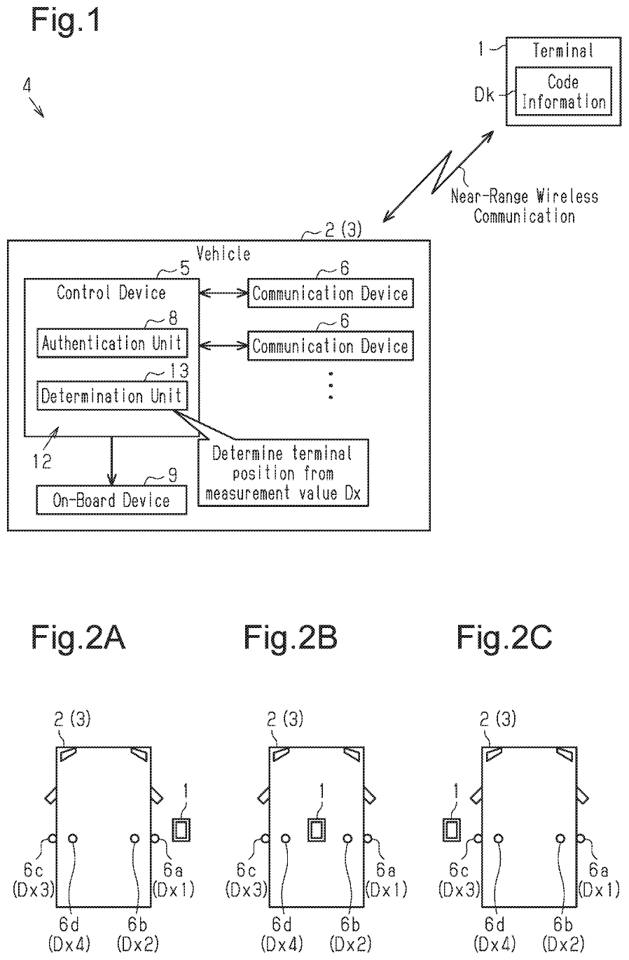

One embodiment of a position determination system will now be described with reference to FIGS. 1 to 5B.

As illustrated in FIG. 1, a vehicle 3 is one example of a subject 2 that is operated by a terminal 1. The vehicle 3 is provided with an authentication system 4 that authenticates the terminal 1 through wireless communication. For example, Bluetooth™ may be used for wireless communication by the authentication system 4. The terminal 1 may be an electronic key that functions a key for the subject 2. Alternatively, the terminal 1 may be a high-performance mobile phone such as a smartphone to which a key-function is registered.

In the present disclosure, the term “subject” is defined as a communication body or a communication station including a communication system device disposed in an interior area (or closed space) that is partitioned from an outer side. The communication body or the communication station systematically executes various types of processes (including verification, authentication, position determination, and the like) described in the present disclosure through wireless communication with the terminal 1. In addition to the vehicle 3, examples of the subject include a house, a building, and any subjects accommodating the communication system device. The communication system device includes operably connected communication/control components, such as one or more communication devices (transceiver, transmitter, or receiver) and a. controller. The communication/control components are formed integrally or separately. The one or more communication devices may be located in the inside the subject (for example, indoors) and/or the outside of the subject (for example. outdoors). Therefore, the subject 2 is not limited to the vehicle 3. The position determination system of the present disclosure does not have to be applied to the vehicle 3 and may be applied to any subjects described above.

The authentication system 4 includes a control device 5 that controls actuation of the authentication system 4. The control device 5 is arranged in the vehicle 3. The control device 5 is connected to one or more communication devices 6 that perform near-range wireless communication. In the present example, communication devices 6 are arranged in the vehicle 3 to form radio wave communication areas around the outer side of the vehicle 3 and throughout the inner side of the vehicle 3 to perform near-range wireless communication with the terminal 1. An example of the near-range wireless communication is Bluetooth™ communication. For example, Bluetooth™ Low Energy (BLE) may be used for Bluetooth™ communication.

As illustrated in FIGS. 2A to 2C, the communication devices 6 include first to fourth communication devices 6a to 6d that are located at positions inside and outside the subject 2. In the present example, the first to fourth communication devices 6a to 6d are respectively located at an outer right side (outside position), an inner right side (inside position), an outer left side (outside position), and an inner left side (inside position) of the vehicle 3 (e.g. vehicle body). The communication devices 6 arranged in the vehicle 3 allow for determination that the terminal 1 is located at the outer right side, the outer left side, or inner side of the vehicle based on combinations of the received signal strength indicators (RSSI) when radio waves from each communication device 6 are received by the terminal 1.

With reference to FIG. 1, the terminal 1 includes a memory (not illustrated) that stores code information Dk used for identification of the terminal 1. For example, the code information Dk may be a single-use code (one-time code) of which the number of times it may be used (e.g., once) is limited. Alternatively, the code information Dk may be a key ID such as an ID code. When the terminal 1 is, for example, a smartphone, the terminal I may download the code information Dk to the memory from an external device such as a server through network communication.

The control device 5 includes an authentication unit 8 that authenticates the terminal 1 through near-range wireless communication with the terminal 1. In the present example, the authentication unit 8 authenticates the code information Dk registered in the terminal 1 through near-range wireless communication with the terminal 1. The authentication unit 8 controls actuation of an on-board device 9 based on an authentication result of the code information Dk. The on-board device 9 may include, for example, a door lock device that locks and unlocks a vehicle door and an engine device that controls an engine.

The Bluetooth™ communication is performed using multiple channels (for example, forty channels) to prevent radio wave interference or the like under a communication environment. Further, in Bluetooth™ communication, frequency hopping is performed at specified timings to switch frequency of the radio waves that are transmitted and received. The terminal 1 and each communication device 6 detect a sequence of frequency hopping (hopping sequence) in advance. Thus, if the combination is legitimate, the terminal 1 and each communication device 6 may transmit and receive radio waves in the specified order of the hopping.

The authentication system 4 includes a position determination system 12 that determines the position of the terminal 1 relative to the vehicle 3. In the present example, the position determination system 12 determines whether the terminal 1 is positioned at the outer right side, the outer left side, or inner side of the vehicle. Since each communication device 6 is fixed in position relative to the vehicle 3, the position of the terminal 1 relative to the vehicle 3 may also be referred to as the position of the terminal 1 relative to each communication device 6.

The position determination system 12 includes a determination unit 13 that determines the position of the terminal 1 relative to each communication device 6. The determination unit 13 is, for example, arranged in the control device 5. The determination unit 13 determines the position of the terminal 1 relative to the communication devices 6 based on a measurement value Dx that indicates the characteristics of the radio waves transmitted between the terminal 1 and each communication device 6. The measurement value Dx may be, for example, the received signal strength indicator (RSSI) of the radio waves transmitted between the terminal 1 and each communication device 6. In the present example, the terminal 1 measures the received signal strength indicator of the radio waves from each communication device 6 and sends the received signal strength indicator data to the corresponding communication device 6 as the measurement value Dx. Further, in Bluetooth™ communication of the present example, the measurement value Dx is measured for each channel. The measurement of the received signal strength indicator may be performed for each communication device 6. For example, when communicating with the terminal 1, each communication device 6 may measure the radio waves transmitted from the terminal 1.

The determination unit 13 repeats a position determination process in a plurality of cycles to determine the present position of the terminal 1 in each of the cycles. Each of the cycles has a predetermined cycle. The position determination process includes a series of processes in which the determination unit 13 obtains the measurement value Dx and determines the position of the terminal 1 relative to each communication device 6 (consequently, position of terminal 1 relative to subject 2) from the measurement value Dx. The position determination process may be executed once in each predetermined cycle, for example, every 50 milliseconds.

The determination unit 13 manages the present position of the terminal 1 through a determination control that allows a position determination result to be maintained over a number of the cycles. For example, the position of the terminal 1 may he erroneously determined in each cycle due to effects of the communication environment or a nearby object. In this case, if the position of the terminal 1 determined in each cycle is reflected (updated) as the determination result of the position of the terminal 1 whenever a cycle ends, the position of the terminal 1 may be erroneously rewritten. Accordingly, the determination unit 13 executes the determination control to maintain the position determination result over a number of cycles until a predetermined position update permission condition is satisfied. In an example of the determination control, which allows the position determination result to be maintained over a number of cycles, when the determination unit 13 determines successively for a predetermined number of times (for example, three times) that the position of the terminal 1 differs from the present position, the determination unit 13 updates the position determination result and changes the present position of the terminal 1 to the successively determined position. In another example, the determination unit 13 maintains the position determination result indicating the present position of the terminal 1 over a certain time.

Operation of the position determination system 12 will now be described with reference to FIGS. 2A to 5B.

Terminal Position Determination

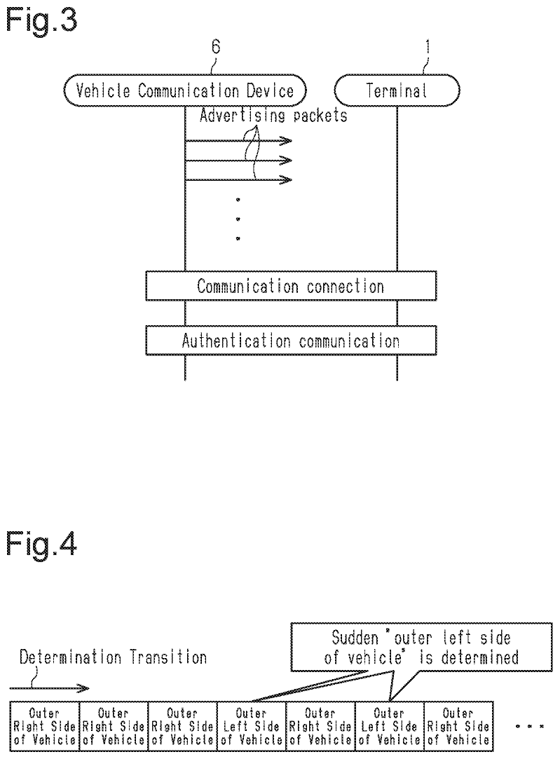

As illustrated in FIG. 3, the authentication unit 8 periodically transmits advertising packets from each communication device 6 to broadcast the existence of each communication device 6 to the surroundings. In the present example, the communication devices 6 sequentially transmit the advertising packets. When the terminal 1 approaches the vehicle 3 and receives the advertising packets from one of the communication devices 6, the terminal 1 performs communication to be paired with that communication device 6. When the pairing is completed, Bluetooth™ communication is established between the terminal 1 and the corresponding communication device 6.

When Bluetooth™ communication is established, the authentication unit 8, for example, performs authentication communication that authenticates the terminal 1. In the authentication communication, the code information Dk registered in the terminal 1 is authenticated. For example, when the code information Dk is a single-use code, the authentication communication may be performed using a terminal ID and an authentication code, which can be obtained when the single-use code is correctly decoded. The terminal ID is an ID that is unique to the terminal 1. The authentication code is used for encryption authentication (for example, challenge-response authentication).

As illustrated in FIGS. 2A to 2C, for example, when authentication communication is performed, the determination unit 13 determines the position of the terminal 1 relative to the vehicle 3. In the present example, the determination unit 13 obtains the received signal strength indicators of the radio waves transmitted from the communication devices 6 and received by the terminal 1 to determine the position of the terminal 1 from the combinations of the obtained received signal strength indicators. In the present example, each communication device 6 includes its registered communication device ID in the radio waves transmitted through near-range wireless communication to the terminal 1. Thus, when the terminal 1 receives radio waves from each communication device 6, the terminal 1 checks the communication device ID included in the radio waves and identifies the corresponding communication device 6.

In the present example, the determination unit 13 obtains the received signal strength indicator as a measurement value Dx1 when the terminal 1 receives radio waves from the first communication device 6a, a measurement value Dx2 when the terminal 1 receives radio waves from the second communication device 6b, a measurement value Dx3 when the terminal 1 receives radio waves from the third communication device 6c, and a measurement value Dx4 when the terminal receives radio waves from the fourth communication device 6d. Alternatively, in Bluetooth™ communication in which radio waves are transmitted using multiple channels, the measurement value Dx may be the average value or the standard deviation of the received signal strength indicators measured for each channel.

As illustrated in FIG. 2A, when the terminal 1 is located at the outer right side of the vehicle 3, the radio waves from the first communication device 6a most easily reach the terminal 1, and the radio waves from the third communication device 6c least easily reach the terminal 1. From this aspect, when the following equation is satisfied, the determination unit 13 determines that the terminal 1 is located at the outer right side of the vehicle 3.

Dx1≥(Dx2, Dx4)≥Dx3 (1)

When the determination equation (1) is satisfied, the determination unit 13 concludes that the present position of the terminal 1, or the position determination result, is “the outer right side of the vehicle”. Here, (Dx2, Dx4) in the determination equation (1) indicates that whichever one of Dx2 and Dx4 is greater does not matter.

As illustrated in FIG. 2B, when the terminal 1 is located inside the vehicle 3, the radio waves from the second communication device 6b and the fourth communication device 6d most easily reach the terminal 1, and the radio waves from the first communication device 6a and the third communication device 6c least easily reach the terminal 1. From this aspect, when the following equation is satisfied, the determination unit 13 determines that the terminal 1 is located inside the vehicle.

(Dx1, Dx3)<(Dx2, Dx4) (2)

When the determination equation (2) is satisfied, the determination unit 13 concludes that the present position of the terminal 1, or the position determination result, is “the inner side of the vehicle”. Here, (Dx1, Dx3) in equation (2) indicates that whichever one of Dx1 and Dx3 is greater does not matter, and (Dx2, Dx4) indicates that whichever one of Dx2 and Dx4 is greater does not matter.

As illustrated in FIG. 2C, when the terminal 1 is located at the outer left side of the vehicle 3, the radio waves from the third communication device 6c most easily reach the terminal 1, and the radio waves from the first communication device 6a least easily reach the terminal 1. From this aspect, when the following equation is satisfied, the determination unit 13 determines that the terminal 1 is located at the outer left side.

Dx3≥(Dx2, Dx4)≥Dx1 (3)

When the determination equation (3) is satisfied, the determination unit 13 concludes that the present position of the terminal I, or the position determination result, is “the outer left side of the vehicle”. Here, (Dx2, Dx4) in the determination equation (3) indicates that whichever one of Dx2 and Dx4 is greater does not matter.

In the present example, when the control device 5 authenticates the terminal 1 that is located at “the outer right side of the vehicle”, the control device 5 permits locking and unlocking of the right side door of the vehicle 3. When the control device 5 authenticates the terminal 1 that is located at “the outer left side of the vehicle”, the control device 5 permits locking and unlocking of the left side door of the vehicle 3. Further, when the control device 5 authenticates the terminal 1 that is located at “the inner side of the vehicle”, the control device 5 permits starting of the engine. This, in turn, allows the user to start driving the vehicle 3.

Changing (Updating) Position Determination Result

As illustrated in FIG. 4, when the position determination in the predetermined cycle is repeatedly performed, the determination of “the outer right side of the vehicle” and the determination of “the outer left side of the vehicle” may alternately be repeated due to the communication environment of the near-range wireless communication. FIG. 4 illustrates an example in which a determination of “the outer left side of the vehicle” is suddenly given after successive determinations of “outer right side”. It has been experimentally confirmed that such position determinations do occur. However, a user would not be able to move between the outer right side and left side of the vehicle 3 in such a short time. Thus, such position determination should be considered as an error.

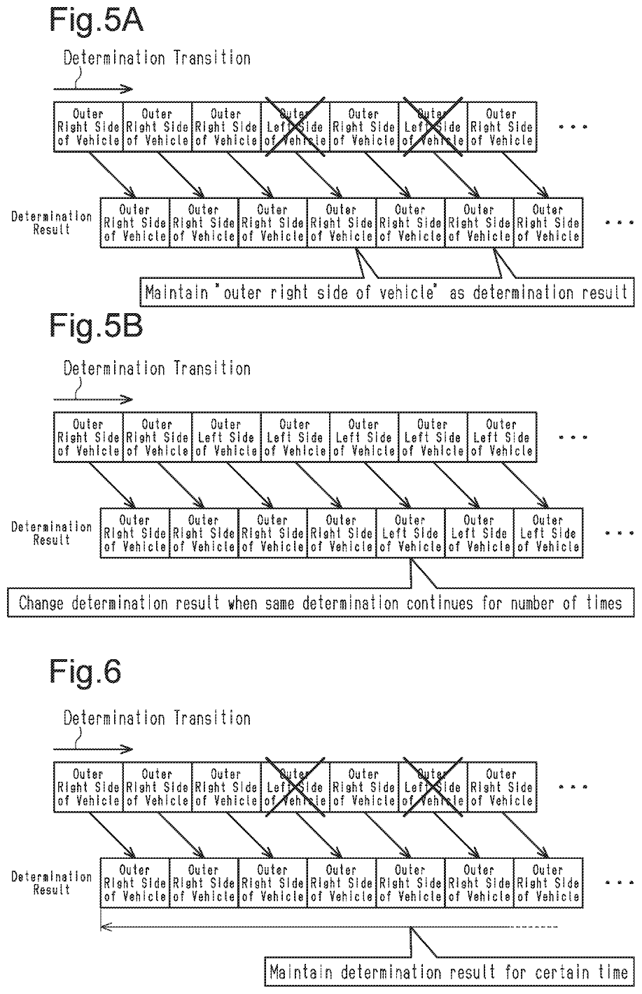

Accordingly, the determination unit 13 executes the determination control to maintain the position determination result over a number of cycles until the predetermined position update permission condition is satisfied. For example, as illustrated in FIG. 5A, unless the determination unit 13 determines successively for a predetermined number of times that the position of the terminal 1 differs from the present position, the determination unit 13 maintains the present position of the terminal 1 (i.e. position determination result). Thus, if the determination unit 13 determines only once that the position of the terminal 1 differs from the present position, such a determination will be considered as being invalid and the present position of the terminal 1 will be maintained. In the example of FIG. 5A, when the determination unit 13 has determined that the present position of the terminal 1 is “the outer right side of the vehicle” but then suddenly determines only once that the position of the terminal 1 is “the outer left side of the vehicle” in the following cycle, the determination unit 13 will ignore the determination (outer left side) and maintain the present position of the terminal 1 (outer right side) as the position determination result.

As illustrated in FIG. 5B, when the determination unit 13 determines successively for a predetermined number of times that the position of the terminal 1 differs from the present position, the determination unit 13 determines that the position update permission condition is satisfied. In this case, the determination unit 13 updates the position determination result and changes the present position of the terminal 1 to the successively determined position. In the example of FIG. 5B, when the determination unit 13 has determined that the present position of the terminal 1 is “the outer right side of the vehicle” and then determines in the following cycle that the position of the terminal 1 is “the outer left side of the vehicle,” if the same determination is successively repeated for a predetermined number of times (for example, three times), the determination unit 13 updates the position determination result and change the present position of the terminal 1 from “the outer right side of the vehicle” to “outer left side of the vehicle”. In this manner, the determination unit 13 updates the position determination result only when there is a high probability that the position of the terminal 1 has actually changed. This avoids position determination errors.

The position determination system 12 of the above embodiment has the advantages described below

(1) The position determination system 12 includes the determination unit 13, obtains the measurement value Dx of the radio waves transmitted between the terminal 1 and each communication device 6, determines the position of the terminal 1 relative to the communication device 6 based on the measurement value Dx, and repeats this series of processes in a plurality of cycles each having the predetermined cycle to determine the present position of the terminal 1. Further, the determination unit 13 determines the position of the terminal 1 through the determination control that allows a determination result to be maintained over a number of cycles.

With this configuration, the position of the terminal 1 is determined through the determination control that allows a determination result of the terminal position to be maintained over a number of cycles. Thus, even when the determination result suddenly changes due to, for example, the effects of the communication environment or a nearby object, the present determination result is maintained without being affected by such conditions. This avoids unintentional and frequent changes of the determination result when the position of the terminal 1 has not changed. Thus, the accuracy of position determination is high.

(2)The terminal 1 and the communication device 6 perform communication using multiple channels. The determination unit 13 determines the position of the terminal 1 relative to the communication device 6 based on the measurement value Dx, which is measured for each channel. This allows the terminal 1 and the communication device 6 to perform communication that resists the effect of radio wave interference.

(3) A plurality of communication devices 6 is used. The determination unit 13 obtains the measurement value Dx of the radio waves transmitted between each communication device 6 and the terminal 1 to determine the position of the terminal 1 by comparing the measurement values Dx of the communication devices 6. Thus, the determination unit 13 checks the position of the terminal 1 relative to each communication device 6 and accurately determines the position of the terminal 1.

(4) The terminal 1 and each communication device 6 perform communication through hopping that switches the frequency of the radio waves when communicating with each other. Thus, when the terminal 1 communicates with the communication device 6, the terminal 1 and communication device 6 both require the sequence of the frequency hopping. This is advantageous for preventing establishment of illegitimate communication.

(5) When the determination unit 13 gives a determination result that differs from the present determination result and is repeated successively for a predetermined number of times, the determination unit 13 changes the present determination result to the repeated determination result in this manner, unless another determination result that differs from the present determination result is repeated for a predetermined number of times, the determination unit 13 maintains the present determination result. Thus, for example, even if an erroneous determination result is suddenly given, the correct present determination result is maintained without being affected by the erroneous determination.

(6) The determination unit 13 determines at which side of the subject 2 the terminal 1 is located relative to the subject 2, on which the communication device 6 is arranged. This allows the side of the subject 2 where the terminal 1 is located, for example, the left or right side of the subject 2, to be determined with high accuracy.

The above-described embodiment may be modified as follows. The above embodiment and the following modifications may be combined as long as the combined modifications remain technically consistent with each other.

Another Example of Determination Control Allowing Position Determination Result to Be Maintained Over Number of Cycles

As illustrated in FIG. 6. the determination control may be a control that maintains the determination result indicating the present position of the terminal 1 over a certain time (or predetermined time). For example, in the leftmost cycle illustrated in FIG. 6, the determination unit 13 determines that the present position of the terminal 1 (position determination result) is “the outer right side of the vehicle”. The determination unit 13 may start measuring time at a time point at which the present position is determined. Subsequently, the determination unit 13 maintains the present position (position determination result) until a certain time (or predetermined time) elapses even if a position that differs from the present position is determined. Then, when the certain time elapses, the determination unit 13 determines that the position update permission condition is satisfied and updates the position determination result based on the position of the terminal 1 that is determined in one or more following cycles. In this case, in the same manner as illustrated in FIG. 5B, the determination unit 13 may update the position determination result when the position of the terminal 1 that differs from the present position is determined successively for a predetermined number of times. The determination control illustrated in FIG. 6 also prevents the position determination result from being frequently and alternately switched between “the outer right side of the vehicle” and “the outer left side of the vehicle”. Further, the determination unit 13 can determine whether to update the position determination result through a simple determination control based on the measured time.

Instead of and/or in addition to updating the position determination result when a position that differs from the present position is determined successively for a predetermined number of times and/or maintaining the position determination result over a certain time, the position determination result may be maintained, for example, over a predetermined number of cycles.

Terminal Position Determination and Measurement Value Dx

The determination of the position of the terminal 1 does not have to be obtained by comparing the measurement value Dx of the radio waves from each communication device 6 with the radio wave measurement values of the other communication devices 6. For example, the position of the terminal 1 may be determined by comparing the received signal strength indicators of the radio waves from each communication device 6 with a threshold value.

The number of positions outside the subject 2, which is determined as the position of the terminal 1 relative to the subject 2, is not limited to two and may be three or more. For example, when the subject 2 is the vehicle 3, the positions outside the vehicle 3 may include an outer rear side (near back door) of the vehicle in addition to the outer right side and the outer left side of the vehicle.

The measurement value Dx used for the determination of the position of the terminal 1 is not limited to the received signal strength indicator and may be, for example, another parameter such as the distance between the terminal 1 and each communication device 6.

The radio wave characteristic used for determination by the determination unit 13 is not limited to the received signal strength indicator and may be a parameter that varies in accordance with the position of the terminal 1 relative to each communication device 6 (distance, interference characteristics, or the like).

Communication between Terminal 1 and Each Communication Device 6

The radio waves used for the position determination may be of any type as long as the radio waves are transmitted and received between the terminal 1 and each communication device 6.

The near-range wireless communication is not limited to Bluetooth™ communication and may be, for example, another communication system such as WiFi™.

The communication between the terminal 1 and each communication device 6 is not limited to near-range wireless communication and may be of another communication protocol.

Authentication System 4

The authentication system 4 (for example, authentication unit 8) may calculate the distance between the terminal 1 and each communication device 6 and use the calculated distance as a parameter for determining whether to establish communication.

When the vehicle 3 includes an electronic key system, the authentication system 4 may be included in the electronic key system. In the electronic key system, an electronic key ID registered to an electronic key is authenticated through wireless communication with the vehicle 3. The electronic key may be the terminal 1 or another electronic device. The wireless communication used in the electronic key system includes smart communication, in which ID verification is performed based on the communication initiated by the vehicle 3 (for example, authentication unit 8), and/or wireless communication, in which ID verification is performed based on the communication initiated by the electronic key.

There is no limitation on the number of the communication devices 6 and the number may be, for example, one.

The authentication communication performed between the authentication unit 8 and the terminal 1 is not limited to Bluetooth™ communication and may be another communication protocol.

The authentication of the terminal 1 by the authentication unit 8 is not limited to the authentication of the code information Dk and may be any authentication that determines the authenticity of the terminal 1.

Others

The terminal 1 is not limited to a smartphone or an electronic key and may be any terminal belonging to a user such as a tablet computer.

Computer System

Any one or more of a plurality of devices included in the position determination system 12 of the present disclosure (for example, terminal 1, control device 5, authentication unit 8, determination unit 13, and/or communication device 6) may be configured as a computer system including one or more processors and a non-transitory memory that stores instructions. The instructions are executable by the processors to perform various types of processes (including verification, authentication, and position determination of present disclosure) in accordance with any one of the above embodiments and modified examples. For example, the one or more processors may be mounted on the subject 2 and implemented as the control device 5 (authentication unit 8 and determination unit 13). In this case, the processors execute the position determination process of the present disclosure by reading instructions stored in the non-transitory memory and executing the instructions. Alternatively, any one or more of devices included in the position determination system 12 may be configured by dedicated hardware such as an application specific integrated circuit (ASIC).

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A position determination system, comprising:
a determination unit that obtains a measurement value indicating a characteristic of radio waves transmitted between a communication device and a terminal, repeats a position determination process that determines a position of the terminal relative to the communication device from the measurement value in a plurality of cycles each having a predetermined cycle, and determines a present position of the terminal in each of the cycles,
wherein the determination unit manages the present position of the terminal through a determination control that allows a position determination result to be maintained over a number of the cycles.

2. The position determination system according to claim 1, wherein
the communication device and the terminal perform communication using a plurality of channels, and
the determination unit determines the position of the terminal relative to the communication device based on the measurement value measured for each channel of the plurality of channels.

3. The position determination system according to claim 1, wherein
the communication device is one of a plurality of communication devices, and
the determination unit obtains a plurality of measurement values for the plurality of communication devices through communication between the terminal and each communication device of the plurality of communication devices to compare the plurality of measurement values and determine the position of the terminal.

4. The position determination system according to claim 1, wherein the communication device and the terminal perform communication while executing frequency hopping that switches a frequency of the radio waves.

5. The position determination system according to claim 1, wherein when the determination unit determines successively for a predetermined number of times that a position of the terminal differs from the present position of the terminal, the determination unit updates the position determination result and changes the present position of the terminal to the successively determined position.

6. The position determination system according to claim 1, wherein the determination unit maintains the position determination result that indicates the present position of the terminal over a certain time.

7. The position determination system according to claim 1, wherein the determination unit determines the position of the terminal relative to a subject in which the communication device is arranged.

8. A computer system, comprising:
one or more processors; and
a non-transitory memory that stores instructions which are executable by the processors to execute a position determination process,
wherein the position determination process includes
obtaining a measurement value that indicates a characteristic of radio waves transmitted between a communication device arranged in a subject and a terminal,
determining a present position of the terminal relative to the subject from the measurement value,
determining whether a position update permission condition is satisfied,
maintaining a position determination result that indicates the present position of the terminal until the position update permission condition is satisfied, and
allowing for updating of the position determination result in response to determining the position update permission condition has been satisfied.

9. The computer system according to claim 8, wherein
the determining a present position of the terminal includes repeating the position determination process in a plurality of cycles each having a predetermined cycle to determine the present position of the terminal in each of the cycles, and
the position update permission condition includes at least one of
successively determining for a predetermined number of times that a position of the terminal differs from the present position of the terminal, and
a certain time having elapsed from when the present position of the terminal was determined.
